(19) United States
(12) Patent Application Publication
(10) Pub. No.: US 2024/0072368 A1
(43) Pub. Date: Feb. 29, 2024

(54) BATTERY PACK VENTING SYSTEM AND VENTING METHOD

(71) Applicant: Ford Global Technologies, LLC, Dearborn, MI (US)

(72) Inventors: John Sturza, Royal Oak, MI (US); Josh Portelli, Grosse Ile, MI (US); Louis Paspal, Canton, MI (US); Christine Maria Cardenas-Graham, Farmington Hills, MI (US); Ronald Grant Smith, Livonia, MI (US)

(21) Appl. No.: 17/894,017

(22) Filed: Aug. 23, 2022

(51) Int. Cl. H01M 50/342

(52) U.S. Cl. CPC H01M 50/3425; H01M 2220/20

(57) ABSTRACT

A battery pack venting system includes a traction battery pack having at least one array of battery cells and a structural member having an interior. The array is configured to vent into the interior. a traction battery pack venting method includes opening a vent to an interior of a structural member. At a position between a first axial end of the structural member and an opposite, second axial end of the structural member, the method includes venting a gas from at least one array of a traction battery pack into the interior, and then venting gas from the interior.

### TECHNICAL FIELD

This disclosure relates generally to venting a traction battery pack of a vehicle and, more particularly, to venting the traction battery pack through a structural member of the vehicle.

### BACKGROUND

A battery pack of an electrified vehicle can include groups of battery cells arranged in one or more battery arrays. From time to time, pressure within one the battery cells can increase and then be released through a vent in that battery cell.

### SUMMARY

In some aspects, the techniques described herein relate to a battery pack venting system, including: a traction battery pack having at least one array of battery cells; and a structural member having an interior, the at least one array configured to vent into the interior.

In some aspects, the techniques described herein relate to a system, wherein the structural member is a sidewall of the traction battery pack.

In some aspects, the techniques described herein relate to a system, wherein the sidewall is an extruded sidewall.

In some aspects, the techniques described herein relate to a system, wherein the structural member includes a plurality of separate channels within the interior, the channel each extending longitudinally from a first end of the structural member to an opposite, second end of the structural member.

In some aspects, the techniques described herein relate to a system, wherein some of the plurality of separate channels open to an interior of the traction battery pack to provide a vent path from the interior of the traction battery pack.

In some aspects, the techniques described herein relate to a system, wherein some of the plurality of separate channels do not open to the interior of the traction battery pack.

In some aspects, the techniques described herein relate to a system, wherein the plurality of separate channels are vertically misaligned from each other.

In some aspects, the techniques described herein relate to a system, wherein a venting of the at least one array is venting to a channel within the plurality of separate channels other than a vertically uppermost channel and a vertically lowermost channel.

In some aspects, the techniques described herein relate to a system, wherein the structural member is a rocker of a vehicle.

In some aspects, the techniques described herein relate to a system, further including a sheet metal enclosure structure of the traction battery pack, the sheet metal enclosure structure including an opening to vent the at least one array.

In some aspects, the techniques described herein relate to a system, wherein the sheet metal enclosure structure is an enclosure tray.

In some aspects, the techniques described herein relate to a system, further including a vent cover configured to transition from a closed position to an open position to provide a path to vent the at least one array into the interior.

In some aspects, the techniques described herein relate to a system, wherein the vent cover is tape having at least a polymer-based layer and an adhesive layer.

In some aspects, the techniques described herein relate to a system, wherein the tape is configured to rupture to transition the tape from a closed position to an open position.

In some aspects, the techniques described herein relate to a system, wherein the at least one array includes a first array and a second array, the first array configured to vent into the interior through a first opening, the second array configured to vent into the interior through a second opening.

In some aspects, the techniques described herein relate to a system, wherein the second opening is aft the first opening along a longitudinal axis of a vehicle having the traction battery pack.

In some aspects, the techniques described herein relate to a traction battery pack venting method, including: opening a vent to an interior of a structural member; at a position between a first axial end of the structural member and an opposite, second axial end of the structural member, venting a gas from at least one array of a traction battery pack into the interior; and venting gas from the interior.

In some aspects, the techniques described herein relate to a method, further including venting gas from the interior at the first axial end, the second axial end, or both.

In some aspects, the techniques described herein relate to a method, further including redirecting the gas within the interior.

In some aspects, the techniques described herein relate to a method, further including opening the vent by rupturing the vent.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack according to an exemplary embodiment of the present disclosure.

FIG. 2 illustrates a perspective view of a battery array from the traction battery pack of FIG. 1.

FIG. 3 illustrates an expanded view of the traction battery pack of FIG. 1.

FIG. 4 illustrates a perspective view of a tray of the traction battery pack of FIG. 1.

FIG. 5 illustrates a section view taken at line 5-5 in FIG. 4.

FIG. 6 illustrates a perspective view of a tray and structural members according to another exemplary embodiment of the present disclosure.

### DETAILED DESCRIPTION

This disclosure details exemplary systems and method for venting an array of battery cells. A path used for venting extends through an interior of a structural member of the vehicle, such as a sidewall of a traction battery pack or a rocker.

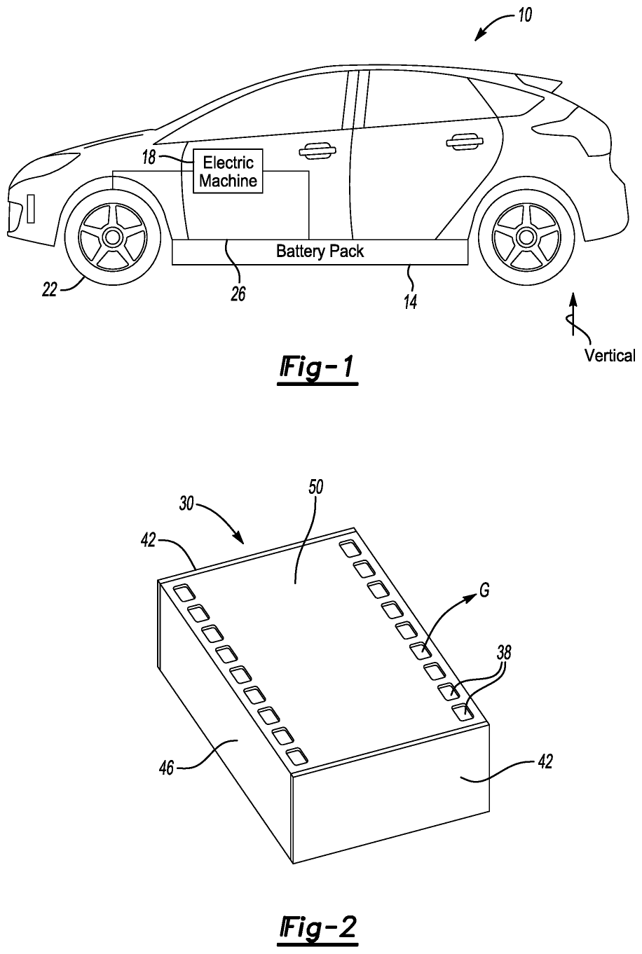

With reference to FIG. 1, an electrified vehicle 10 includes a traction battery pack 14, an electric machine 18, and wheels 22. The battery pack 14 powers an electric machine 18, which converts electric power to torque to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a traction battery pack.

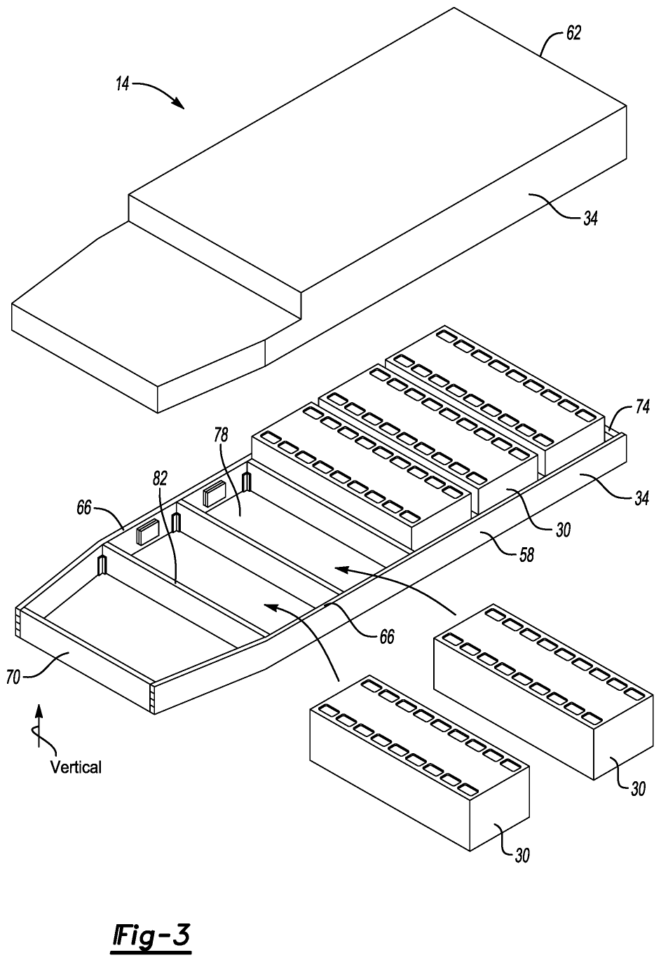

Referring now to FIGS. 2 to 4 with continuing reference to FIG. 1, the battery pack 14 includes a plurality of battery arrays 30 housed in an enclosure 34. The battery arrays 30 are groups of individual battery cells 38 arranged in a rows. In an embodiment, the battery cells 38 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

In this example, the battery cells 38 of the arrays 30 are compressed between the endplates 42. The arrays 30 each further include side plates 46 that cover the outboard sides of the battery cells 38, and a top plate 50 that extends over the vertically upper surfaces of the battery cells 38. Vertical, for purposes of this disclosure is with reference to ground and a general orientation of the vehicle 10 during operation.

From time to time, pressure and temperature within one of the battery cells 38 can increase and cause the battery cell 38 to rupture. After rupturing, gas G from an interior of the battery cell 38 is discharged and vented from the battery cell 38. Although described as a single one of the battery cells 38 venting, more than one of the battery cells 38 can be venting at the same time. The gas G that is vented from the battery cells 38 can include effluents.

The gas G vented from the battery cell 38 can flow from the battery cell 38 through at least one opening 54 in the top plate 50 as shown in FIG. 2. The gas G is then outside the array 30, but within the enclosure 34. The system and methods of this disclosure related to conveying the gas G to an area outside the vehicle 10.

In this example, the enclosure 34 includes a tray 58 and a cover 62. The tray 58 includes sidewalls 66, a forward wall 70, an aft wall 74, and a floor 78. The tray 58, in this example, includes cross-members 82 that extend in a cross-vehicle direction between the sidewalls 66. When the cover 62 is secured to the tray 58, the enclosure 34 completely encloses the arrays 30.

The sidewalls 66, the forward wall 70, the aft wall 74, and the cross-members 82 are extruded structures in this example. A person having skill in this art and the benefit of this disclosure would understand how to structurally distinguish an extruded structure from a structure that is not extruded. Specifying that the noted structures are “extruded” thus implicates structure to these components.

The sidewalls 66 extend longitudinally along a passenger side and a driver side of the battery pack 14. Each of the sidewalls 66 extends from a first end 86 to an opposite second end 90. In this example, the first ends of the sidewalls 66 are closer to a front of the vehicle 10 (FIG. 1) than the second ends. For purposes of this disclosure, front and rear, and forward and aft are with reference to a general orientation of the vehicle 10 during operation.

The sidewalls 66 are structural members of the battery pack 14. The sidewalls 66 can help to support the battery pack 14. The battery pack 14 can be secured to the underbody 26 of the vehicle 10 through the sidewalls 66. The sidewalls 66 can help to protect the battery pack 14 against an external load.

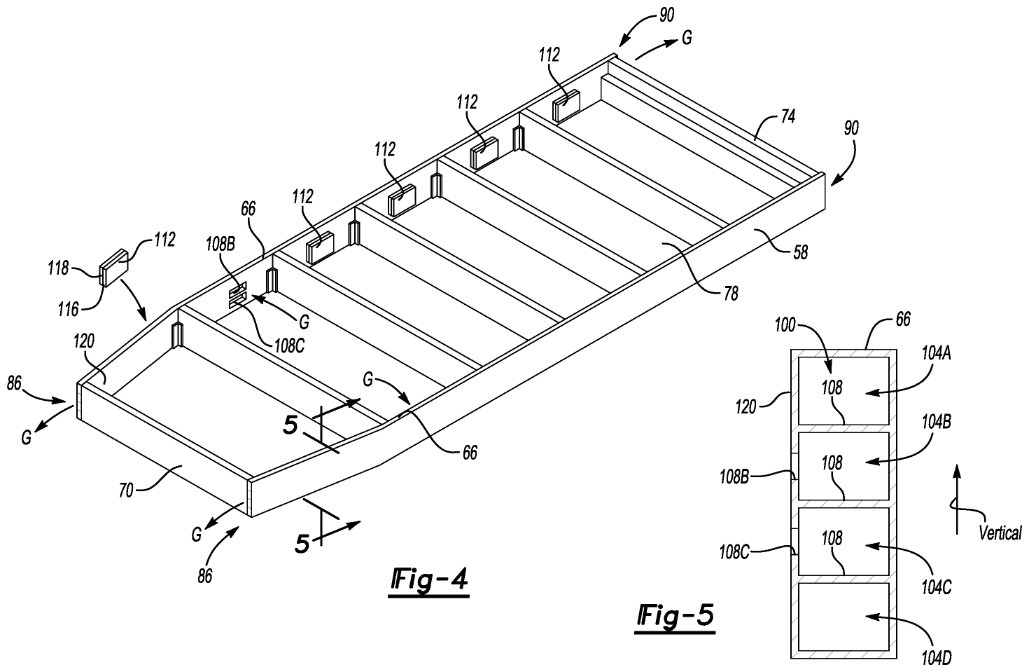

With reference now to FIG. 5 and continued reference to FIG. 4, the sidewalls 66 each have an interior 100 that extends from the first end 86 and second end 90. The interior 100 of the example sidewalls 66 is segmented into a plurality of separate channels 104A-104D. In the example sidewalls 66, the channels 104 are vertically stacked and are separated from each other by webs 108 that span from inboard sides of the sidewalls 66 to outboard sides of the sidewalls 66. As the channels 104A-104D are vertically stacked, the channels 104A-104D are vertically misaligned.

The interior 100 of each of the sidewalls 66 includes four channels 104A-104D in this example. In other examples, more than four or fewer than four channels 104A-104D could be used. In some examples, the interior 100 is open and omits any webs 108 or channels 104A-104D.

In this example, at least some of the channels 104A-104D within the interior 100 are used to communicate gas G vented from one or more of the battery cells 38 to an area outside the battery pack 14 and outside the vehicle 10. In this specific example, two of the channels 104A-104D are used for venting. The two channels used for venting are the vertically central channels 104B and 104C, not the vertically uppermost channel 104A or the vertically lowermost channel 104D. In other examples, all the channels 104A-104D could be used for venting.

To provide paths for the gas G to enter the channels 104B and 104C, the sidewalls 66 are machined after being extruded. The machining creates a plurality of openings 108B to the channels 104B and a plurality of openings 108C to the channels 104C. Other openings could be required if the channels 104A and 104D were also used for venting.

The openings 108B and 108C are generally aligned with one of the arrays 30 along a longitudinal axis of the vehicle 10. The plurality of openings 108B and 108C are between the first end 86 and the second end 90 of the sidewalls 66.

During ordinary operation of the battery pack 14 of the vehicle 10, a plurality of vent covers 112 are used to cover the openings 108B and 108C. The vent covers 112 can, for example, block debris and moisture outside the battery pack 14 from entering the enclosure 34 through the interior 100 of the respective sidewall 66.

Each of the example vent covers 112 covers one of the openings 108B and one of the openings 108C. In this example, the vent covers 112 are provided by a multi-layered tape having at least a polymer-based layer 116 and an adhesive layer 118. The adhesive layer 118 secures the vent cover 112 to an inboard surface 120 of the sidewalls 66 and covers the openings 108B and 108C. In some examples, the vent covers 112 include a foil layer.

The channels 108A and 108D do not include openings to the interior of the enclosure 34. Because there are no openings to the channels 108A and 108D, additional surface area on the sidewalls 66 is available to secure the vent covers 112.

If a venting event occurs in the cells 38 of one of the arrays 30, the gas G melts or otherwise rupture the vent cover 112 near that array 30. This transitions the vent cover 112 from a closed position to an open position.

When the vent cover 112 is in the open position, the gas G can move through the openings 108B and 108C into the interior 100 of the sidewalls 66 and, more particularly, into the channels 104B and 104C of the interior 100. The gas G is redirected within the interior 100 and communicates through the channels 104B and 104C from the first end 86, the second end 90, or both, to an area surrounding the vehicle 10.

In this example, the vent covers 112 are used to cover the openings 108B and 108C. In another example, the vent covers 112 could instead or additionally be used to cover the openings at the first end 86 and the second end 90 of the sidewalls 66.

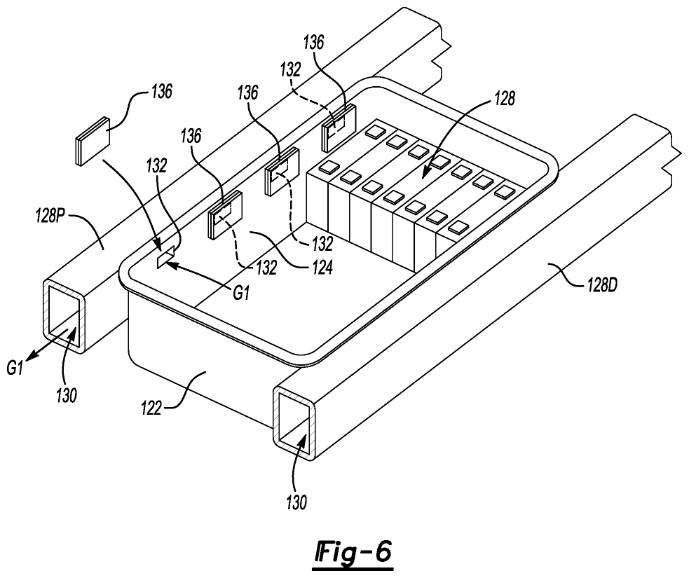

As shown in FIG. 6, another example tray 122 includes sidewalls 124. A plurality of arrays 128 of battery cells can be held in the tray 122 between the sidewalls 124 and enclosed by a cover (not shown). The tray 122 is a stamped sheet metal enclosure structure in this example. Since the sidewalls 124 are a sheet of material, the sidewalls 124 lack an interior area.

When a battery pack having the tray 122 is installed within a vehicle, the tray 122 can fit between a driver side rocker 128D and a passenger side rocker 128P of the vehicle 10. The rockers 128D and 128P are structural members of the vehicle 10 that, in this example, include an interior 130.

The tray 122 and rockers 128D, 128P are machined to include a plurality of openings 132 or pass-throughs. During ordinary operation, the openings 132 can be covered by a vent cover 136 that is similar to the vent cover 112. The vent cover 136 can rupture or otherwise open in response to one more battery cells venting gas G₁. The vented gas G₁ can then move from an interior of the stamped sheet metal tray 122 into the interior 130 of one of the rockers 128P or 128D, and then from the interior 130 to an area surrounding the vehicle.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting system, comprising:
a traction battery pack having at least one array of battery cells; and
a structural member having an interior, the at least one array configured to vent into the interior.

2. The system of claim 1, wherein the structural member is a sidewall of the traction battery pack.

3. The system of claim 2, wherein the sidewall is an extruded sidewall.

4. The system of claim 1, wherein the structural member includes a plurality of separate channels within the interior, the channel each extending longitudinally from a first end of the structural member to an opposite, second end of the structural member.

5. The system of claim 4, wherein some of the plurality of separate channels open to an interior of the traction battery pack to provide a vent path from the interior of the traction battery pack.

6. The system of claim 5, wherein some of the plurality of separate channels do not open to the interior of the traction battery pack.

7. The system of claim 4, wherein the plurality of separate channels are vertically misaligned from each other.

8. The system of claim 7, wherein a venting of the at least one array is venting to a channel within the plurality of separate channels other than a vertically uppermost channel and a vertically lowermost channel.

9. The system of claim 1, wherein the structural member is a rocker of a vehicle.

10. The system of claim 9, further comprising a sheet metal enclosure structure of the traction battery pack, the sheet metal enclosure structure including an opening to vent the at least one array.

11. The system of claim 10, wherein the sheet metal enclosure structure is an enclosure tray.

12. The system of claim 1, further comprising a vent cover configured to transition from a closed position to an open position to provide a path to vent the at least one array into the interior.

13. The system of claim 12, wherein the vent cover is tape having at least a polymer-based layer and an adhesive layer.

14. The system of claim 13, wherein the tape is configured to rupture to transition the tape from a closed position to an open position.

15. The system of claim 1, wherein the at least one array includes a first array and a second array, the first array configured to vent into the interior through a first opening, the second array configured to vent into the interior through a second opening.

16. The system of claim 15, wherein the second opening is aft the first opening along a longitudinal axis of a vehicle having the traction battery pack.

17. A traction battery pack venting method, comprising:
opening a vent to an interior of a structural member;
at a position between a first axial end of the structural member and an opposite, second axial end of the structural member, venting a gas from at least one array of a traction battery pack into the interior; and
venting gas from the interior.

18. The method of claim 17, further comprising venting gas from the interior at the first axial end, the second axial end, or both.

19. The method of claim 17, further comprising redirecting the gas within the interior.

20. The method of claim 17, further comprising opening the vent by rupturing the vent.
